(19) United States
(12) Patent Application Publication
(10) Pub. No.: US 2019/0227377 A1
(43) Pub. Date: Jul. 25, 2019

(54) DISPLAY DEVICE

(71) Applicant: InnoLux Corporation, Miao-Li County (TW)

(72) Inventors: Jia-Yuan Chen, Miao-Li County (TW); Tsung-Han Tsai, Miao-Li County (TW); Kuan-Feng Lee, Miao-Li County (TW); Ping-Chieh Hsu, Miao-Li County (TW)

(21) Appl. No.: 15/876,207

(22) Filed: Jan. 22, 2018

(51) Int. Cl. G02F 1/1335; G02F 1/1339; G02F 1/1362

(52) U.S. Cl. CPC G02F 1/133533; G02F 1/1339; G02F 1/136286; G02F 1/1368; G02F 2001/133565; G02F 2001/133548; G02F 1/133514

(57) ABSTRACT

A display device includes a first substrate, a second substrate, a plurality of pixels, a polarizing member, and a sealing member. The plurality of pixels are disposed between the first substrate and the second substrate. The polarizing member is disposed between the plurality of pixels and the second substrate, wherein a first area is defined by the polarizing member. The sealing member is disposed between the first substrate and the second substrate, wherein a second area is defined by the sealing member. The first area is located within the second area.

### BACKGROUND OF THE DISCLOSURE

### 1. Field of the Disclosure

The present disclosure relates to a display device, and more particularly, to a display device including a polarizing member.

### 2. Description of the Prior Art

Nowadays, display devices have advantages of portability, low power consumption, and low radiation. Therefore, they are widely used in various information products, such as desktop computers, notebooks, smart phones, car displays and head up displays.

Conventionally, in order to provide different color light for different pixels, a color filter layer is disposed in the display device, which permits specific color lights with predetermined wavelength ranges to pass through but absorbs other color lights that are out of the predetermined wavelength ranges in individual pixels, so as to display colorful images. However, the light absorption of the color filter layer decreases the light utility efficiency, and the color saturation is also an issue for the display device with the color filter layer.

### SUMMARY OF THE DISCLOSURE

It is one of the objectives of the present disclosure to provide a display device that have an improved light utility efficiency.

The present disclosure provides a display device includes a first substrate, a second substrate, a plurality of pixels, a polarizing member, and a sealing member. The plurality of pixels are disposed between the first substrate and the second substrate. The polarizing member is disposed between the plurality of pixels and the second substrate, wherein a first area is defined by the polarizing member. The sealing member is disposed between the first substrate and the second substrate, wherein a second area is defined by the sealing member. The first area is located within the second area.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a sectional schematic diagram of a display device according to a first embodiment of the present disclosure.

FIG. 2 is a top-view schematic diagram of the display device shown in FIG. 1

FIG. 3 is a schematic diagram illustrating the light converting material according to the present disclosure.

FIG. 4 is a sectional schematic diagram of a display device according to a second embodiment of the present disclosure.

FIG. 5 is a sectional schematic diagram of a display device according to a third embodiment of the present disclosure.

FIG. 6 is a sectional schematic diagram of a display device according to a fourth embodiment of the present disclosure.

FIG. 7 is a sectional schematic diagram of a display device according to a fifth embodiment of the present disclosure.

FIG. 8 is a top-view schematic diagram of the display device shown in FIG. 7

FIG. 9 is a sectional schematic diagram of a display device according to a sixth embodiment of the present disclosure.

FIG. 10 is a sectional schematic diagram of a display device according to a seventh embodiment of the present disclosure.

### DETAILED DESCRIPTION

The present disclosure may be understood by reference to the following detailed description, taken in conjunction with the drawings as described below. It is noted that, for purposes of illustrative clarity and being easily understood by the readers, various drawings of this disclosure show a portion of the display device, and certain elements in various drawings may not be drawn to scale. In addition, the number and dimension of each device shown in drawings are only illustrative and are not intended to limit the scope of the present disclosure.

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include”, “comprise” and “have” are used in an open-ended fashion, and thus should be interpreted to mean “include, but not limited to . . . ”.

When the corresponding component such as layer or area is referred to “on another component (or the variant thereof)” or “extend to another component”, it may be directly on another component or directly extend to another component, or other component may exist between them. On the other hand, when the component is referred to “directly on another component (or the variant thereof)” or “directly extend to another component”, any component does not exist between them. When an element or layer is referred to as being “connected to” another element or layer, it can be directly connected to the other element or layer, or intervening elements or layers (indirectly) may be presented. In contrast, when an element is referred to as being “directly connected to” another element or layer, there are no intervening elements or layers presented. In addition, when the component is referred to “be coupled to/with another component (or the variant thereof)”, it may be directly connected to another component, or may be indirectly connected (such as electrically connected) to another component through other component or components.

When the terms “include”, “comprise” and/or “have” are used in the description of the present disclosure, the corresponding features, areas, steps, operations and/or components would be pointed to existence, but not limited to the existence of one or a plurality of the corresponding features, areas, steps, operations and/or components.

It should be noted that the technical features in different embodiments described in the following can be replaced, recombined, or mixed with one another to constitute another embodiment without departing from the spirit of the present disclosure.

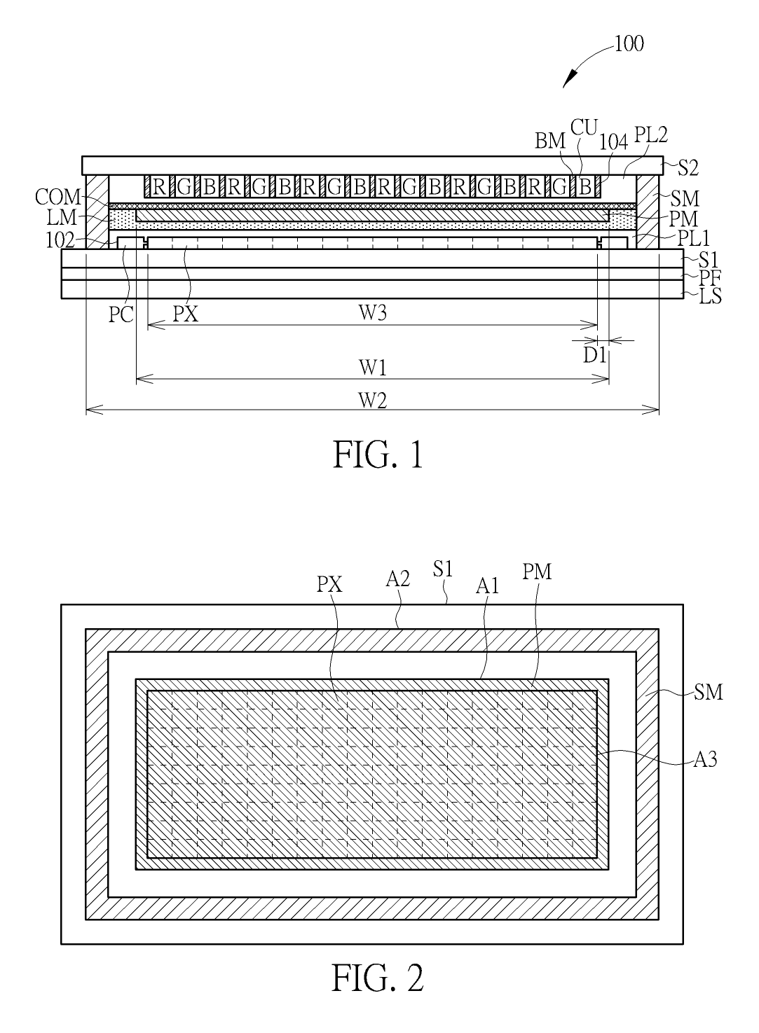

Referring to FIG. 1 and FIG. 2, FIG. 1 is a sectional schematic diagram of a display device according to a first embodiment of the present disclosure, and FIG. 2 is a top-view schematic diagram of the display device shown in FIG. 1, wherein some elements are omitted in FIG. 2 for clearly illustration. In the first embodiment of the present disclosure, the display device 100 includes a first substrate S1, a second substrate S2, a plurality of pixels PX, a polarizing member PM, and a sealing member SM. The second substrate S2 is disposed opposite to the first substrate S1, and the second substrate S2 and the first substrate S1 are disposed substantially in parallel to each other. The first substrate S1 and the second substrate S2 may independently be a hard substrate such as a glass substrate, a plastic substrate, a quartz substrate or a sapphire substrate, or may independently a flexible substrate such as a polyimide (PI) substrate, a polycarbonate (PC) substrate, or a polyethylene terephthalate (PET) substrate, but not limited thereto. The plurality of pixels PX (or sub-pixels) are disposed between the first substrate S1 and the second substrate S2. In this embodiment, the pixels PX are arranged as an array and are formed with a circuit array layer 102 on the first substrate S1. The pixels PX represent the display units with operation elements in the circuit array layer 102. For example, one pixel PX may include a part of a data line, a part of a scan line, a switch element (such as a thin film transistor), a pixel electrode, and a capacitor included in the circuit array layer 102, but not limited thereto. In other words, the arrangement of the pixels PX defines a display region of the display device 100 on the first substrate S1, and the portion of the first substrate S1 out of the display region is defined as a peripheral region. In this embodiment, the peripheral region surrounds the display region, but not limited thereto. In some other embodiments, the peripheral region is only located at one or several sides of the display region. Furthermore, in some embodiments, the circuit array layer 102 may further include one or more peripheral circuit PC disposed in the peripheral region and between the plurality of pixels PX and the sealing member SM. For example, the peripheral circuit PC may include, but not limited to, peripheral wires or peripheral lines, drivers, connecting structures and common lines. In this embodiment, a first passivation layer PL1 is disposed on the first substrate S1 and covers the circuit array layer 102 for protecting the plurality of pixels PX and the peripheral circuit PC. The first passivation layer PL1 may be an insulation layer that includes organic material (such as performic acid, PFA) or inorganic material (such as SiOx or SiNx), or may include a composite stacking structure, but not limited thereto.

The sealing member SM is disposed between the first substrate S1 and the second substrate S2 for connecting the second substrate S1 and the first substrate S1 for forming a cell. The material of the sealing member SM may include epoxy, resin, acryl, frit, or metal, but not limited thereto. The polarizing member PM is disposed between the first substrate S1 and the second substrate S2. The polarizing member PM could be an inner-cell-polarizer, which means the polarizing member PM may be an inner polarizer. In an embodiment, the polarizing member PM may include polyvinyl alcohol (PVA) material. For example, the polarizing member PM may be a PVA film attached on the second substrate S2. In another embodiment, the polarizing member PM may include a wire grid polarizer (WGP) or other kinds of inner-cell-polarizer, wherein the WGP may include aluminum, titanium, copper, any combination thereof, or any other suitable material(s). In this embodiment, in FIG. 2, the area (occupation area) of the polarizing member PM is smaller than the area enclosed by the sealing member SM. In another saying, a first area A1 is defined by the outer edge of the polarizing member PM, a second area A2 is defined by the outer edge of the sealing member SM, the first area A1 is less than the second area A2, and the first area A1 of the polarizing member PM is located within the second area A2 enclosed by the sealing member SM. The polarizing member PM is located within the sealing member SM. In addition, FIG. 1 represents the cross-sectional view along any horizontal direction of the display device 100, and FIG. 1 shows the relative relation of the widths of the first area A1 and the second area A2. As shown in FIG. 1, a first width W1 of the first area A1 is defined by the polarizing member PM, a second width W2 of the second area A2 is defined by the outer edge of the sealing member SM, the first width W1 is less than the second width W2, and the first width W1 is located within the second width W2. The relative relation and locations of the first width W1 and the second width W2 also represent that the first area A1 is located within the second area A2. Furthermore, as shown in FIG. 1 and FIG. 2, the polarizing member PM is surrounded by the sealing member SM and is spaced apart from the sealing member SM.

In another aspect, the area of the polarizing member PM is greater than or equal to the area of the display region, which is the occupation area of the array of the pixels PX. The area of the display region is located within or is fitted with the area of the polarizing member PM. Furthermore, a third width W3 is defined by the plurality of the pixels PX. The third width W3 is less than or equal to the first width W1, and the third width W3 is located within or is fitted with the first width W1. The relative relation and locations of the third width W3 and the first width W1 represent that a third area A3 (shown in FIG. 2) of the plurality of the pixels PX is less than or equal to the first area A1 and the third area A3 is located within or is fitted with the first area A1, wherein the third area A3 may be considered as the display region of the display device 100. In this embodiment, the first width W1 is greater than the third width W3 and is protruded from an edge of the third width W3 that is adjoining to the edge of the first width W1 by 2.5 millimeters (mm) to 5 millimeters (mm). In other words, there is an interval D1 between the edge of the first width W1 and the edge of the third width W3, wherein the interval D1 ranges from 2.5 mm to 5 mm. This design provides an assembling tolerance of 5 mm to 10 mm in the width and/or length of the polarizing member PM such that the polarizing member PM can cover the plurality of pixels PX. In addition, the polarizing member SM could partially overlap the peripheral circuit PC in this embodiment.

The display device 100 may selectively include a light source LS and a light converting layer 104. The light source LS is disposed at a side of the first substrate S1 opposite to the second substrate S1, which is the backside of the display device 100 form the user point of view. In this embodiment, the light source LS produces light with dominant wavelength segment less than or equal to 490 nanometers, but not limited thereto. Dominant wavelength segment is a wavelength segment (range) corresponding to a concentrated higher intensity region in the spectrum of light. For example, the light source LS may produce blue light. In some embodiments, the light source LS may produce ultraviolet (UV) light. The light converting layer 104 is disposed between the polarizing member PM and the second substrate S2. The light converting layer 104 include light converting materials and can convert the spectrum of the light emitted from the light source LS into different spectrum for forming different kinds of color light. The light converting layer 104 may include a plurality of converting units CU which are separated from each other by a light blocking portion BM. The light blocking portion BM may include any material that can block, absorb, refract, scatter, or reflect light, such as metal material, black inorganic material, black organic materials or photoresist materials. In this embodiment, a second passivation layer PL2 is disposed on the surface of the second substrate S2 and covers the light converting layer 104, which can protect the light converting layer 104. The material of the second passivation layer PL2 may be one of the above-mentioned materials of the first passivation layer PL1, and redundant introduction will not be described herein.

In this embodiment, the converting units CU are divided into, but not limited to, three types and can individually produce different color lights with different spectrums when the light from the light source LS penetrates into the light converting layer 104. The different kinds of converting units CU include different light converting materials respectively. For example, the light converting materials of the converting units CU include quantum dot materials. In the converting units CU marked by “R”, the quantum dot material can convert one spectrum of light with lower dominant wavelength segment into another spectrum of light with higher dominant wavelength segment ranged from 580 nm to 780 nm, which may be considered as red light. In the converting units CU marked by “G”, the quantum dot material can convert one spectrum of light with lower dominant wavelength segment into another light spectrum with higher dominant wavelength segment ranging from 490 nm to 575 nm, which may be considered as green light. In the converting units CU marked by “B”, the converting units CU may have quantum dots for blue light or have transparent material with no quantum dots in the case that the light emitted from the light source LS is blue light. However, in some embodiments, when the light source LS produces UV light, the converting units CU marked by “B” may include quantum dot material that can convert UV light spectrum into another spectrum of light with higher dominant wavelength segment ranged from 380 nm to 490 nm, which may be considered as blue light. Those skilled in the art may understand the amount of kinds of the converting units CU and the color of converted light are only illustrated as examples, which are not intended to limit the present disclosure.

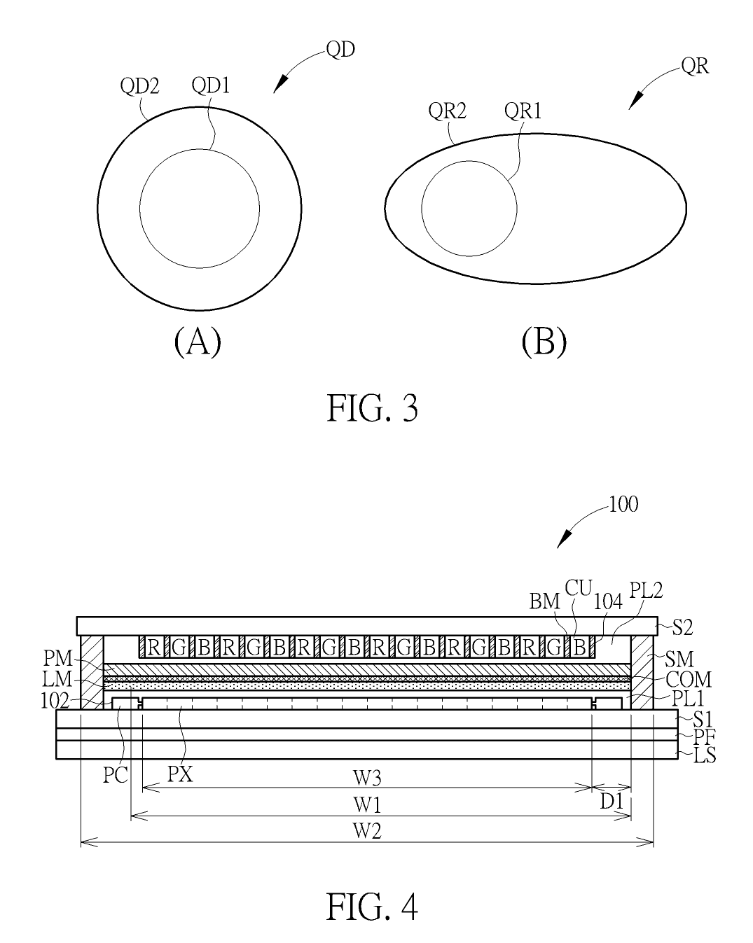

Referring to FIG. 3, FIG. 3 is a schematic diagram illustrating the light converting material according to the present disclosure. As shown in the part (A) of FIG. 3, the quantum dot QD of the light converting material in this embodiment may be composed of a shell QD2 and a core QD1 disposed therein. The core QD1 mainly determines the color of the converted light, and the shell QD2 provides a protection effect to the core QD1. For example, the shell QD2 may mitigate the damage and/or degradation of the core QD1 caused by the environment variation and the attack of light or oxygen. In another aspect, the shell QD2 can reduce the surface defect and provide light path. In some embodiments, the material of the quantum dot QD may be composed of II-VI, IV-VI, and III-V semiconductor materials. For example, the material of the core QD1 may include at least one compound selected from CdSe, CdS, CdTe, ZnS, ZnSe, ZnTe, CdSeTe, CdZnS, CdSeS, PbSe, PbS, PbTe, AgInZnS, HgS, HgSe, HgTe, GaN, GaP, GaAs, InP, InZnP, InGaP, InGaN, InAs, and ZnO, and the material of the shell QD2 may include at least one compound selected from CdS, CdSe, CdTe, CdO, ZnS, ZnSe, ZnTe, ZnO, InP, InS, GaP, GaN, GaO, InZnP, InGaP, InGaN, InZn—SCdSe, PbS, TiO, SrSe, and HgSe, but not limited thereto. As an example, the materials of the core QD1/shell QD2 may be one or more of CdS/Zns, CdSe/ZnS, CdSe/CdS, and InAs/CdSe, but not limited thereto.

Referring to FIG. 1, the display device 100 may selectively further include a light modulating layer LM and a polarizing film PF. The light modulating layer LM is disposed between the first substrate S1 and the second substrate S2. In this embodiment, the light modulating layer LM is disposed between the polarizing member PM and the plurality of pixels PX and is surrounded by the sealing member SM. The light modulating layer LM can modulate the amount of light that passes through the light modulating layer LM and enters the polarizing member PM. For example, the light modulating layer LM includes liquid crystal molecules, but not limited thereto. The polarizing film PF is disposed at a side of the first substrate S1 opposite to the second substrate S2 and is between the light source LS and the polarizing member PM. The polarizing film PF may include a PVA layer or any other suitable material. The display device 100 may selectively further include a common electrode layer COM disposed between the polarizing member PM and the second substrate S2, wherein a common voltage is applied to the common electrode layer COM when the display device 100 is in operation. The common electrode layer COM may include transparent conductive material, such as indium tin oxide (ITO). In one embodiment, the polarizing member PM may be a polarizing film that is attached onto the surface of the common electrode layer COM.

According to the present disclosure, the display device 100 has an inner-polarizer structure, wherein the polarizing member PM is disposed between the first substrate S1 and the second substrate S2, and the polarizing member PM is located within the area (space) that is enclosed by the sealing member SM. The occupation area of the polarizing member PM is less than the occupation area of the second substrate S2, the first area A1 of the polarizing member PM is located within the second area A2 of the second substrate S2, the first width W1 defined by the polarizing member PM is less than the second width W2 defined by the outer edge of the sealing member SM, and the first width W1 defined by the polarizing member PM is located within the second width W2 defined by the outer edge of the sealing member SM. In addition, the polarizing member PM is spaced apart from the sealing member SM in this embodiment. The top edge of the sealing member SM is directly in contact with the lower surface of the second substrate S2 or directly in contact with the film formed on the second substrate S2. The bottom edge of the sealing member SM is also directly in contact with the top surface of the first substrate S1 or directly in contact with the film formed on the first substrate S1. Accordingly, the sealing effect is improved.

The display device in the present disclosure is not limited to the above mentioned embodiment. Further embodiments or variant embodiments of the present disclosure are described below. The technical features in different embodiments described can be replaced, recombined, or mixed with one another to constitute another embodiment without departing from the spirit of the present disclosure. For making it easier to compare the difference between the embodiments and variant embodiments, the following description will detail the dissimilarities among different variant embodiments or embodiments and the identical features will not be redundantly described.

Referring to FIG. 4, FIG. 4 is a sectional schematic diagram of a display device according to a second embodiment of the present disclosure. The main difference between this embodiment and the first embodiment is that the positions of the polarizing member PM and the common electrode layer COM is exchanged and the polarizing member PM has a greater area or a greater width such that the outer edge of the polarizing member PM extends outward to reach the sealing member SM. At least a portion of the polarizing member PM is in contact with the sealing member SM. Despite that, the area of the polarizing member PM is less than or equal to the area enclosed by the sealing member SM. The first width W1 is still within the second width W2, and the top edge and the bottom of the sealing member SM are directly in contact with the second substrate S2 and the first substrate S1 or the films formed thereon respectively. Furthermore, in this embodiment, the polarizing member PM includes a WGP-type polarizer, which is formed on the second substrate S2 before the common electrode layer COM is formed. However, in other embodiments, the polarizing member PM may include PVA or other material with polarization functionality.

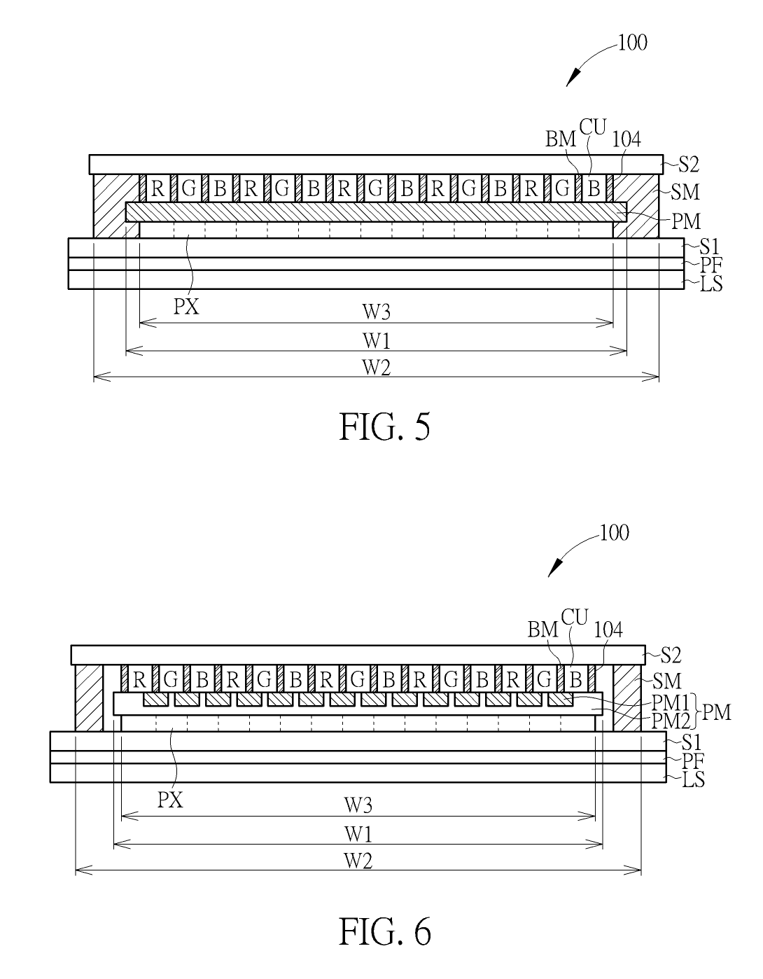

Referring to FIG. 5, FIG. 5 is a sectional schematic diagram of a display device according to a third embodiment of the present disclosure. For emphasizing the differences between this embodiment and the previous embodiments, some elements (such as the passivation layers, the light modulating layer, and the peripheral circuit) are omitted in FIG. 5, as well as other figures of the following embodiments. As shown in FIG. 5, the main difference between this embodiment and the second embodiment is that the sealing member SM partially overlaps the polarizing member PM. Side edge of the polarizing member PM is protruded into and ended up within the sealing member SM. In this situation, the top edge of the sealing member PM is still directly in contact with the second substrate S2 or the films formed on the section substrate S2, and the bottom edge of the sealing member PM is still directly in contact with the first substrate S1 or the films formed on the first substrate S1. In other words, the first width W1 is still within the second width W2, and the area defined by the polarizing member PM is still located within the area defined by the sealing member SM.

Referring to FIG. 6, FIG. 6 is a sectional schematic diagram of a display device according to a fourth embodiment of the present disclosure. The main difference between this embodiment and the first embodiment is that the polarizing member PM includes a polarizer portion PM1 and a protection layer PM2. The polarizer portion PM1 may be formed of WGP material or PVA material for example. The protection layer PM2 is disposed between the polarizer portion PM1 and the plurality of pixels PX and covers the surface of the polarizer portion PM1 for protecting the polarizer portion PM1. The protection layer PM2 may include SiOx or SiNx material, but not limited thereto.

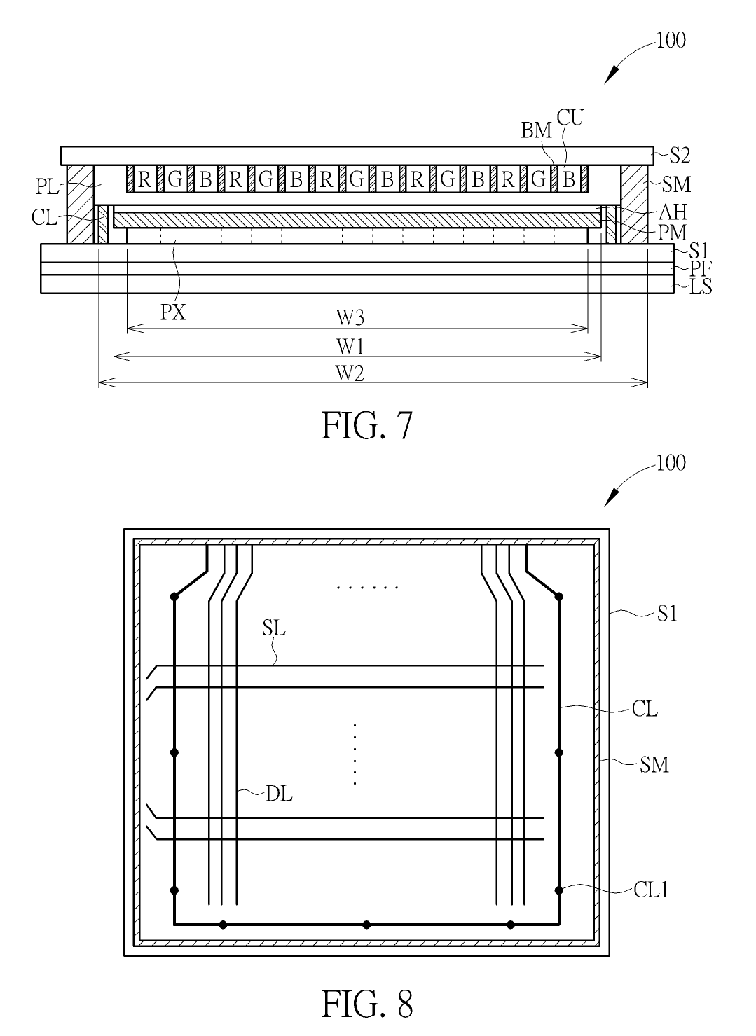

Referring to FIG. 7 and FIG. 8, FIG. 7 is a sectional schematic diagram of a display device according to a fifth embodiment of the present disclosure, and FIG. 8 is a top-view schematic diagram of the display device shown in FIG. 7. Some elements shown in FIG. 7 are omitted in FIG. 8. However, scan lines SL and data lines DL are illustrated for roughly showing the arrangements of the pixels PX. One of the differences between this embodiment and the first embodiment is that the display device 100 further includes a common line CL formed on the surface of the first substrate S1 and disposed between the sealing member SM and the polarizing member PM. The common line CL is disposed in a peripheral region of the first substrate S1, the peripheral region is located between the sealing member SM and the display region. The common line CL may include conductive metal material, conductive metal oxide material, or any other suitable conductive material. According to the present disclosure, the common line CL is surrounded by the sealing member SM to avoid metal corrosion. The common line CL further includes a plurality of common line contact CL1 that is electrically connected to a common electrode formed on the surface of the second substrate S2. Furthermore, a passivation layer PL selectively covers the surface of the light conversion layer 104, and the polarizing member PM is attached onto the surface of the light conversion layer 104 or the passivation layer PL by an adhesive layer AH. In other words, the adhesive layer AH is disposed between the polarizing member PM and the second substrate S2 for binding the polarizing member PM and the second substrate S2.

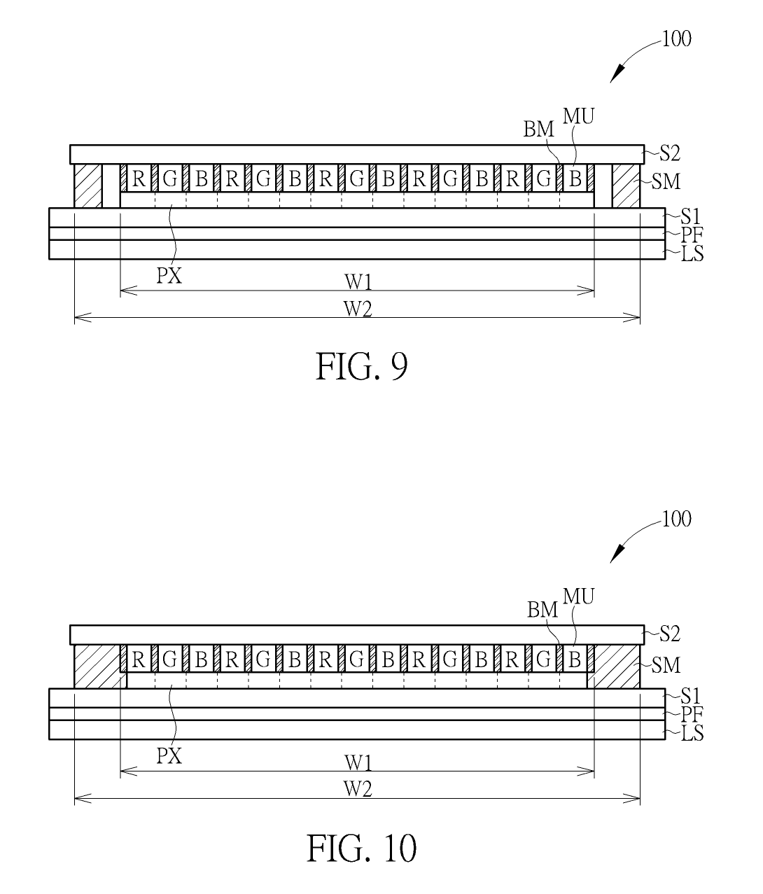

Referring to FIG. 9, FIG. 9 is a sectional schematic diagram of a display device according to a sixth embodiment of the present disclosure. The display device 100 shown in FIG. 9 is different from the previous embodiment in the structure of the polarizing member. In this embodiment, a multi-function unit MU includes a plurality of optical elements with light converting function and light polarizing function, which replaces the polarizing member and the converting units in the previous embodiments. The optical elements include materials such as quantum rod (QR) materials. Referring to the part (B) of FIG. 3, the quantum rod QR may have an oval-shaped shell QR2 that wraps a core QR1. Because the shell QR2 has an elongated axis, it provides polarizing function such that can filter out light with different polarizing directions. The materials of the quantum dot QD introduced above can be referred for the materials of the core QR1 and the shell QR2. Different materials and sizes or diameters of the quantum rod materials may convert the light from the light source LS into different color of light, such as red light, green light, and further blue light. Accordingly, the quantum rods QR included by the multi-function unit MU can convert light color and also serve as a polarizer to filter light via its polarization direction. As a result, the multi-function unit MU in this embodiment replaces the light converting layer 104 in the previous embodiments. The total thickness of the display device 100 can be reduced. Furthermore, the multi-function unit MU overlaps the plurality of pixels PX.

Referring to FIG. 10, FIG. 10 is a sectional schematic diagram of a display device according to a seventh embodiment of the present disclosure. The display device 100 shown in FIG. 10 is different from the sixth embodiment in that the sealing member SM overlaps the multi-function unit MU, the border edge of the multi-function unit MU is protruded into and ended up within the sealing member SM. However, the total first width W1 defined by the multi-function unit MU is still within the second width W2 defined by the sealing member SM in both the sixth embodiment and the seventh embodiment.

According to the present disclosure, the polarizing member is surrounded by the sealing member and located within the area defined by the sealing member. In some embodiments, the polarizing member is spaced apart from the sealing member. In some other embodiments, the polarizing member partially overlaps the sealing member. Accordingly, the sealing member disposed between the first substrate and the second substrate will not be blocked by the polarizing member and will connect the first substrate and the second substrate. In this design, the sealing effect and adhesive effect are improved because the sealing member can be directly in contact with the first substrate (or the film formed thereon) and the second substrate (or the film formed thereon, other than the polarizing member). In addition, a traditional color filter layer is replaced by the light converting layer or the polarizing member of the present disclosure, wherein the light converting materials in the light converting layer or the polarizing member may include quantum dot materials or/and quantum rod materials. The quantum dot materials and the quantum rod materials can directly convert a light with a wavelength range into a light with another wavelength range, which improves the brightness and luminance efficiency in comparison with the traditional color filter layer that filter out about two thirds of the amount of light that enters the color filter layer. The light saturation is improved accordingly. In addition, in the case that the multi-function unit includes quantum rod materials with light converting and polarizing functions, the display device may be thinner.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A display device, comprising:
a first substrate;
a second substrate disposed opposite to the first substrate;
a plurality of pixels disposed between the first substrate and the second substrate;
a polarizing member disposed between the plurality of pixels and the second substrate, wherein a first area is defined by the polarizing member; and
a sealing member disposed between the first substrate and the second substrate, wherein a second area is defined by the sealing member,
wherein the first area is located within the second area.

2. The display device of claim 1, wherein a third area is defined by the plurality of pixels, and the third area is located within the first area.

3. The display device of claim 2, wherein an edge of the first area is protruded from an edge of the third area adjoining to the edge of the first area by an interval ranged from 2.5 mm to 5 mm.

4. The display device of claim 1, wherein the first area is less than an area of the first substrate or an area of the second substrate.

5. The display device of claim 1, wherein the polarizing member overlaps the plurality of pixels.

6. The display device of claim 1, further comprising a light converting layer disposed between the polarizing member and the second substrate.

7. The display device of claim 6, wherein the light converting layer includes quantum dot materials.

8. The display device of claim 1, wherein the polarizing member includes a plurality of light converting elements.

9. The display device of claim 8, wherein the plurality of light converting elements includes quantum rod materials.

10. The display device of claim 1, further comprising an adhesive layer disposed between the second substrate and the polarizing member.

11. The display device of claim 1, wherein a material of the polarizing member includes at least one of wire grid material and polyvinyl alcohol material.

12. The display device of claim 11, wherein the polarizing member further includes a protection layer disposed between the polarizer portion and the plurality of pixels.

13. The display device of claim 1, further comprising a common electrode layer disposed between the polarizing member and the second substrate.

14. The display device of claim 1, further comprising a common electrode layer disposed between the polarizing member and the first substrate.

15. The display device of claim 1, further comprising a common line disposed between the sealing member and the polarizing member, wherein the common line is surrounded by the sealing member.

16. The display device of claim 1, wherein the polarizing member is spaced apart from the sealing member.

17. The display device of claim 1, wherein the sealing member partially overlaps the polarizing member.

18. The display device of claim 1, further comprising a peripheral circuit disposed between the plurality of pixels and the sealing member, wherein the polarizing member only partially overlaps the peripheral circuit.

19. The display device of claim 1, further comprising a light modulating layer disposed between the polarizing member and the plurality of pixels.

20. The display device of claim 1, further comprising a light source disposed on a side of the first substrate opposite to the second substrate, wherein the light source produces light with wavelength less than or equal to 490 nanometers.
